(19) United States
(12) Patent Application Publication
(10) Pub. No.: US 2017/0345097 A1
(43) Pub. Date: Nov. 30, 2017

(54) SYSTEM AND METHOD FOR A GRAPHICAL USER INTERFACE FOR FINANCIAL PLANNING

(71) Applicant: 8696322 Canada Inc., Vaughan (CA)

(72) Inventor: Vijyat Bhalla, Vaughan (CA)

(21) Appl. No.: 15/597,808

(22) Filed: May 17, 2017

Related U.S. Application Data
(60) Provisional application No. 62/343,178, filed on May 31, 2016.

(51) Int. Cl. G06Q 40/06; G06Q 10/06; G06F 3/0484; G06T 11/20; G06F 3/0482

(52) U.S. Cl. CPC G06Q 40/06; G06T 11/206; G06F 3/0482; G06F 3/04847; G06Q 10/067

(57) ABSTRACT

What is disclosed is a graphical user interface (GUI) for one or more user devices associated with one or more users to interact with a financial planning system, wherein said one or more user devices are coupled to said financial planning system via a network; said financial planning system comprises a financial modeling platform (FMP) to generate said GUI for display on said one or more user devices, said GUI further comprising an age ladder comprising a set of age containers, and one or more elements, and manage said GUI. The financial planning system receives commands from said one or more user devices to prompt the display of a month ladder comprising a set of month containers based on one or more interactions with said age ladder, and drop at least one element selected from the one or more elements into at least one of the set of month containers.

### CROSS-REFERENCE TO RELATED APPLICATION(S)

This application claims priority to U.S. Provisional Patent Application No. 62/343,178 filed May 31, 2016.

### FIELD OF THE INVENTION

The present disclosure relates to graphical user interfaces for financial planning.

### BRIEF SUMMARY

A graphical user interface (GUI) for one or more user devices associated with one or more users to interact with a financial planning system, wherein said one or more user devices are coupled to said financial planning system via a network; said financial planning system comprises a financial modeling platform (FMP) to generate said GUI for display on said one or more user devices, said GUI further comprising an age ladder comprising a set of age containers, and one or more elements, and manage said GUI; and wherein said financial planning system receives commands from at least one of said one or more user devices using said GUI to prompt the display of a month ladder comprising a set of month containers at said at least one user device based on one or more interactions with said age ladder, and drop at least one element selected from the one or more elements into at least one of the set of month containers.

A method for one or more user devices to interact with a financial planning system over a network, wherein said one or more user devices is coupled to said financial planning system over the network, further wherein said financial planning system comprises a financial modeling platform (FMP); and said method further comprising generating a graphical user interface (GUI) for display on said one or more user devices using said FMP, wherein said GUI comprises an age ladder comprising a set of age containers, and one or more elements; managing said GUI using said FMP; receiving commands from at least one of said one or more user devices using said GUI to prompt display of a month ladder comprising a set of month containers at said at least one user device based on one or more interactions with said age ladder; select at least one element from the one or more elements; and drop said selected at least one element into at least one of the set of month containers.

A system for one or more user devices associated with one or more users to interact with a financial planning system over a network, wherein said one or more user devices is coupled to said financial planning system over the network, further wherein said financial planning system comprises a financial modeling platform (FMP) to generate a graphical user interface (GUI) for display on said one or more user devices, said GUI further comprising an age ladder comprising a set of age containers, and one or more elements, and manage said generated GUI; wherein said financial planning system receives commands from at least one of said one or more user devices using said GUI to prompt the display of a month ladder comprising a set of month containers at said at least one user device based on one or more interactions with said age ladder, prompt the display of a trio ladder comprising a set of trio containers at said at least one user device based on one or more interactions with said month ladder, and drop at least one element selected from the one or more elements into at least one of the set of trio containers.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 shows an example implementation architecture.

FIG. 2 shows an embodiment of the front end and back end information technology (IT) infrastructure layers of the financial planning system.

FIG. 3 shows an alternative embodiment of the front end and back end IT infrastructure layers of the financial planning system.

FIG. 4 shows an example embodiment of a Graphical User Interface (GUI) used in the financial planning system.

FIG. 5 shows an alternative arrangement of an age ladder in the GUI.

FIG. 6 shows one embodiment of a pull-out panel comprising frequently used elements for placing on the canvas of the GUI.

FIG. 7 shows a graph of income and expenses taking into account the timeline of the elements.

FIG. 8 shows an example flow of a user interaction with the GUI.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

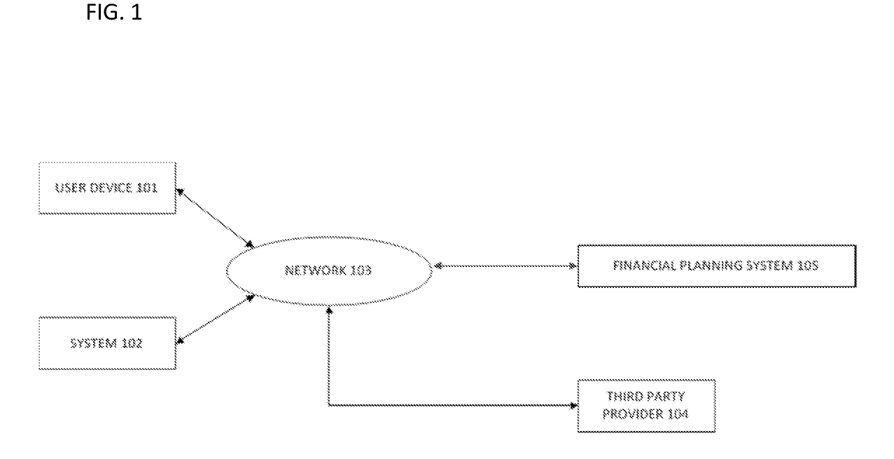

FIG. 1 shows an example architecture to implement the system and method detailed within this specification. In FIG. 1, user device 101 and system 102 are coupled to financial planning system 105 via network 103. User device 101 is, for example, a laptop, smartphone, personal computer, tablet, or wearable device. User device 101 has one or more input devices such as a mouse, keyboard, touchscreen and microphone. User device 101 also has, for example, one or more display units such as stand-alone or mobile monitors or screens attached. System 102 is, for example, a corporate system or an in-house system. Network 103 is, for example, an internal network or an external network, telephone network, local area network, wide area network, personal area network, mesh network, the Internet, cloud or wireless network. Network 103 may comprise a plurality of subnetworks. Third party provider 104 is coupled to user device 101, system 102 and financial planning system 105 via network 103. Third party provider 104 is, for example
a financial institution such as a credit card provider or bank, or
an insurance provider.

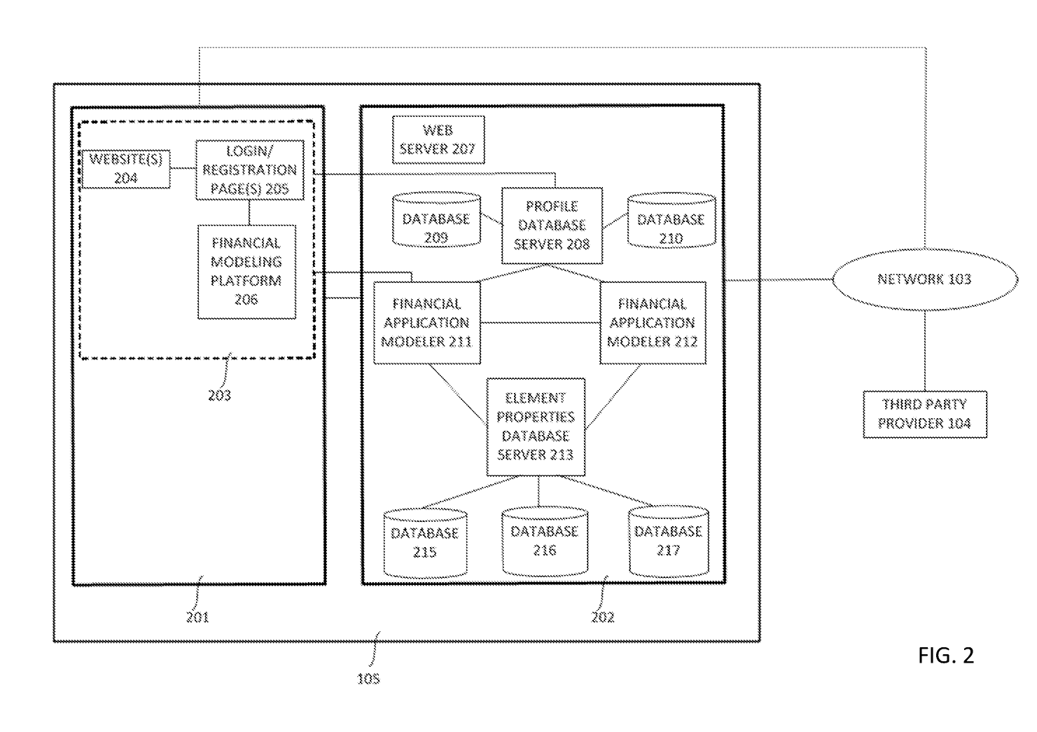

FIG. 2 shows one embodiment of financial planning system 105 to allow a user to interact with financial planning system 105 using a web browser running on user device 101, or via a web browser running on a device which is part of system 102. This allows a user to access financial planning system 105 using any device with web browsing capabilities, including, for example, a laptop, desktop, smartphone and tablet. As shown in FIG. 2, financial planning system 105 comprises front end layer 201 and back end layer 202. Front end layer 201 is coupled to back end layer 202, so as to enable communications between the components of front end layer 201 and back end layer 202. In some embodiments, this coupling is enabled using at least one of wired, wireless and/or optical media. In one embodiment, this coupling is enabled using, for example, a local area network (LAN), wide area network (WAN) or campus area network (CAN). In one embodiment, this coupling is enabled using one or more network technologies known to those of skill in the art, such as Bluetooth, Ethernet, Wi-Fi and TCP/IP. In another embodiment, this coupling occurs over one or more subnetworks. In additional embodiments, some of the components of front end layer 201 are coupled to components of back end layer 202. For example, as shown in FIG. 2, block 203 is coupled to one or more financial application modelers 211 and 212; and profile database server 208.

Front end layer 201 comprises website(s) 204, one or more login/registration pages 205 and Financial Modeling Platform (FMP) 206. Front end layer 201 is coupled to the user device 101 and system 102 of FIG. 1 via network 103.

In one embodiment front end layer 201 is accessed through, for example, a browser running on user device 101 using one or more methods known to those of skill in the art. In this embodiment, the user accesses website(s) 204 of front end layer 201 using the browser. In one embodiment, upon accessing website(s) 204, users are directed to the one or more login/registration pages 205 so as to allow
existing users to login, and
new users to register.

The one or more login/registration pages 205 comprise a login section. In one embodiment, the existing user login process comprises requesting the existing user to enter, for example, a username and password in the login section. In a further embodiment, the existing user login process comprises requesting the user to answer one or more security questions in the login section. In yet another embodiment, the existing user is requested to use a security device to generate and enter a security code as part of the existing user login process.

In one embodiment, new user registration comprises the users creating login details for future logins in a profile creation section within the one or more login/registration pages 205. The process of creating login details comprises, for example,
entering a login user name,
entering a login password,
selecting and answering one or more security questions, and
initializing a security device.

In another embodiment, the profile creation section within the one or more pages 205 allows new users to create a personal profile comprising personal details such as
name,
address,
age,
gender,
annual and monthly income,
annual and monthly expenses,
annual and monthly taxes,
assets,
liabilities,
insurance,
net worth, and
education levels.

These personal details also comprise, for example,
details of bank accounts such as account numbers, account balances, financial institutions where these accounts are held;
credit card details such as balances, card numbers, credit card providers; and
insurance details such as monthly payments, insurance providers and amounts insured.

Once new user registration is complete, new users are directed to the login section within one or more login/registration pages 205 so as to enable them to login.

In yet another embodiment, when users want to amend their previously created profiles once they are logged in, users access the profile creation section to amend their previously created personal profiles.

Once the users are logged in, FMP 206 is activated. The FMP 206 is a platform comprising one or more modules. Each of these one or more modules has their own features and functionalities. These modules comprise, for example:
a budget management module with real-time capabilities such as
   expense categorization, and
   income categorization
a planning and forecasting module, and
an investment and portfolio management module,

In one embodiment, the activation of FMP 206 comprises generating a Graphical User Interface (GUI) which is customized to the logged-in user. The GUI will be described in further detail below. The user, via user device 101, utilizes the GUI to interact with the FMP 206 and the one or more modules.

The FMP 206 is responsible for the management, generation and handling of the GUI. The FMP 206 receives user inputs from the GUI and performs operations in response to the received user inputs. These operations include, for example:
performing one or more computational tasks and algorithms necessary for the functioning of the FMP 206;
displaying the results of the performance of the one or more computational tasks and algorithms on the GUI; and
generating one or more tables, graphs and spreadsheets for display within the GUI.

In one embodiment, as shown in FIG. 2, website(s) 204, one or more login/registration pages 205 and FMP 206 are grouped together within a block 203. The operations necessary for the functioning of block 203 are performed using a combination of the resources of:
the back-end layer 202, and
the user device 101.

In the embodiment shown in FIG. 2, back end layer 202 comprises web server 207, one or more financial application modelers 211 and 212, profile database server 208, elements properties database server 213 and databases 209, 210, 215, 216 and 217. In one embodiment, as shown in FIG. 2 the components of back end layer 202 are coupled to each other using one or more techniques known to those of skill in the art. In some embodiments, this coupling is performed using at least one of wired, wireless and optical media. In one embodiment, this coupling is performed using, for example, a local area network (LAN), wide area network (WAN) or campus area network (CAN). In one embodiment, this coupling is performed using one or more network technologies known to those of skill in the art, such as Bluetooth, Ethernet, TCP/IP and Wi-Fi. In another embodiment, this coupling is performed using one or more subnetworks.

As shown in FIG. 2, in an exemplary embodiment back end layer 202 is coupled to the network 103. Back end layer 202 is also coupled to, for example, third party provider 104 via network 103.

In an example embodiment, web server 207 performs some of the operations necessary for the functioning of block 204. This includes, for example, hosting website(s) 204. In another example embodiment, web server 207 performs some of these necessary operations in conjunction with one or more of the other components of back-end layer 202. For example, web server 207 interacts with profile database server 208 to retrieve user profile information from one or more of databases 209 and 210 and create, for example, Hyper Text Markup Language (HTML) or JavaScript or Active Server Pages Extended (ASPX) files that are customized to the user's profile. In one embodiment, web server 207 communicates with one or more financial application modelers 211 and 212 to enable the functioning of block 203. Web server 207 will be described in further detail below.

In one embodiment, profile database server 208 performs the tasks necessary to facilitate the operation of the one or more login/registration pages 205 described above, such as:
receiving information including the personal details explained above and login details supplied by the user from the one or more login/registration pages 205,
processing the received information,
storing this received information in, for example, one or more database components 209 and 210, and
retrieving information from one or more databases 209 and 210.

In one embodiment, the one or more financial application modelers 211 and 212, together with one or more of the:
web server 207;
profile database server 208;
the element properties database server 213; and
databases 209, 210, 215, 216 and 217

perform some of the tasks necessary for the functioning of block 203. Examples of these tasks include:
the tasks necessary to facilitate the operation of the one or more login/registration pages 205 as described above, and
tasks necessary to facilitate the operation of FMP 206, which include
   customizing the GUI generated by the FMP 206 based on the user profile information; and
   performing the FMP 206 operations described above.

Elements properties database server 213, and databases 215, 216 and 217, will also be described in further detail below.

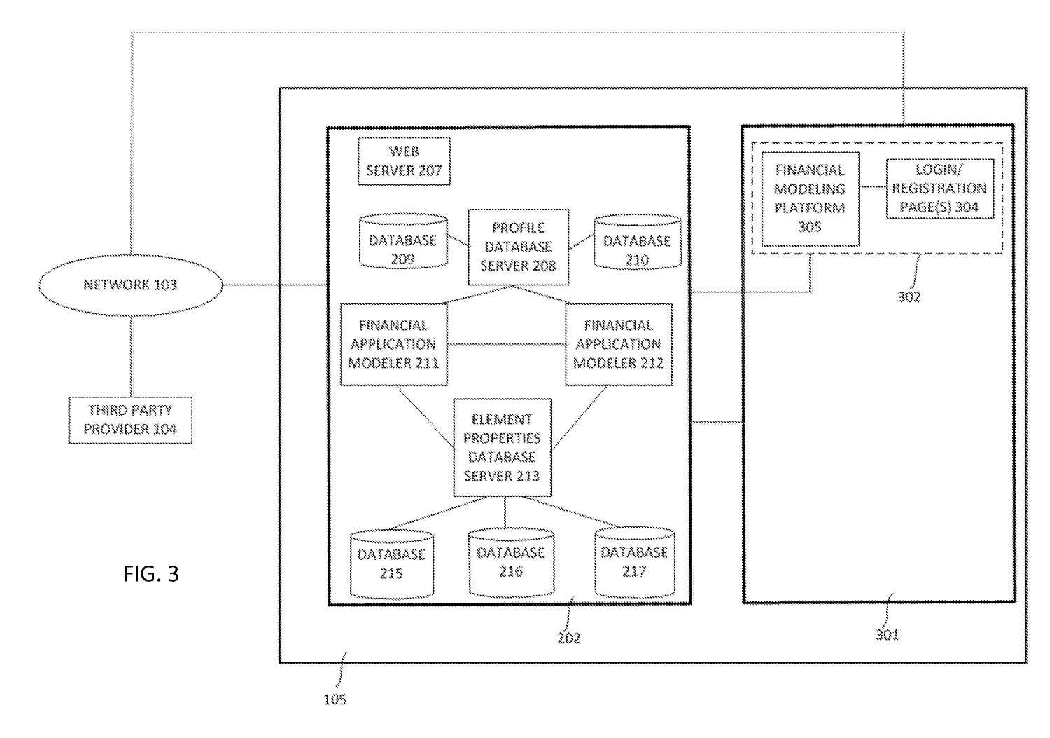

FIG. 3 shows another embodiment which allows the user to interact with financial planning system 105 using a native mobile application. This applies to situations where user device 101 is a mobile device, such as a tablet or a smartphone; or where a mobile device which is part of system 102 interacts with the financial planning system 105. Similar to FIG. 2, financial system 105 comprises two layers, front end layer 301 and back end layer 202. As shown in FIG. 3, front end layer 301 is coupled to back end layer 202 to enable communication between the components of front end layer 301 and back end layer 202. In some embodiments, this coupling is performed using at least one of wired, wireless and optical media. In one embodiment, this coupling is performed using, for example, a local area network (LAN), wide area network (WAN) or campus area network (CAN). In one embodiment, this coupling is performed using one or more network technologies known to those of skill in the art, such as Bluetooth, Ethernet, TCP/IP and Wi-Fi. In another embodiment, this coupling occurs using one or more subnetworks. In additional embodiments, some of the components of front end layer 301 are coupled to back end layer 202. For example, as shown in FIG. 3, block 302 is coupled to one back end layer 202. Additionally front end layer 301 is coupled to the user device 101 and system 102 of FIG. 1 via network 103.

Front end layer 301 comprises one or more login/registration pages 304 and FMP 305. The operation of these components has been described previously. In the embodiment shown in FIG. 3, one or more login/registration pages 304 and FMP 305 are downloaded, installed and accessed on user device 101 as a native mobile application 302. The mobile application 302 is downloaded from, for example, an application or “app” store such as the Apple® App Store®, or the Google® Play™ Store.

The operations necessary for the functioning of mobile application 302 are performed using a combination of the resources of:
the back-end layer 202, and
the user device 101.

The user has to either login or register using the one or more login/registration pages 304 in order to use the mobile application 302. The data supplied by the user during the login/registration process is sent to the back end layer 202 for storage and/or authentication.

In one example embodiment, the supplied login/registration data is transmitted to one or more financial application modelers 211 and 212, which will then interact with the profile database server 208 to:
authenticate the user using the information stored in one or more database components 209 and 210; or
in the case of new user registration, store user profile data in the one or more database components 209 and 210.

In another example embodiment, the FMP 305 operations are performed using a combination of the resources of:
the one or more financial application modelers 211 and 212; and
user device 101.

Similar to FIG. 2, as shown in FIG. 3 in some embodiments back end layer 202 is coupled to the network 103, and third party provider 104 via network 103.

The components of back end layer 202 of FIG. 2 and FIG. 3 will now be described in detail. As explained above, back end layer 202 comprises web server 207, which is responsible for the hosting and running of websites such as website(s) 204 of FIG. 2. Web server 207 performs operations such as:
storing one or more pages necessary for the running of website(s) 204 of FIG. 2; and
receiving and processing requests from users for access to information on the website(s) 204 of FIG. 2.

In one embodiment, the web server 207 runs one or more programs and languages necessary for the performance of its functions and operations. Examples include but are not limited to Hyper Text Transfer Protocol (HTTP), Cascading Style Sheets (CSS) and/or Hyper Text Markup Language (HTML). In one embodiment, the web server 207 is implemented using one or more servers. In another embodiment, the web server 207 is implemented using a cloud-based implementation. In other embodiments, the web server 207 is implemented in software, hardware or a combination of software and hardware.

Some of the operations of the profile database server 208 have been described above. Additionally, profile database server 208 works to store and retrieve information from databases 209 and 210. Profile database server 208 also works together with one or more components of back end layer 202 such as web server 207 and one or more financial application modelers 211 and 212 to perform some of the operations which take place in the back end layer 202. Profile database server 208 runs one or more database programs and languages known to those of skill in the art such as Structured Query Language (SQL). In one embodiment, the profile database server 208 is implemented using one or more servers. In another embodiment, the profile database server 208 is implemented using a cloud-based implementation. In other embodiments, the profile database server 208 is implemented in software, hardware or a combination of software and hardware.

In one embodiment, as explained previously, one or more financial application modelers 211 and 212, together with one or more of the components of back-end layer 202, are responsible for facilitating the operation of FMP 206 in the front end layer. In embodiments where profile database server 208 controls the operation of the one or more login/registration pages 304 in the front end layer, one or more financial application modelers 211 and 212 communicate with profile database server 208 to extract user information entered in the one or more login/registration pages 304. In one embodiment, the one or more financial application modelers 211 and 212 run one or more programs and languages necessary for the performance of its functions and operations. Examples include but are not limited to JavaScript. In one embodiment, the one or more financial application modelers 211 and 212 is implemented using one or more servers. In another embodiment, the one or more financial application modelers 211 and 212 is implemented using a cloud-based implementation. In other embodiments, the one or more financial application modelers 211 and 212 is implemented in software, hardware or a combination of software and hardware.

In another embodiment, one or more financial application modelers 211 and 212 further interact with an element properties database server 213 which captures element parameters and stores them into databases 215 to 217. Elements and element parameters will be further explained below. In one embodiment, the element properties database server 213 runs database programs and languages known to those of skill in the art such as Structured Query Language (SQL). In one embodiment, the element properties database server 213 is implemented using one or more servers. In another embodiment, the element properties database server 213 is implemented using a cloud-based implementation. In other embodiments, the element properties database server 213 is implemented in software, hardware or a combination of software and hardware.

As explained previously for FIG. 2 and FIG. 3, in some embodiments back-end layer 202 is coupled to third party provider 104 via network 103. This enables one or more of the components of back end layer 202 such as one or more financial application modelers 211 and 212 to communicate with third party provider 104 to retrieve data and perform operations. For example, when third party provider 104 is a financial institution, then one or more components of back end layer 202 has access to data such as user account details, details of outstanding mortgages and credit card balances.

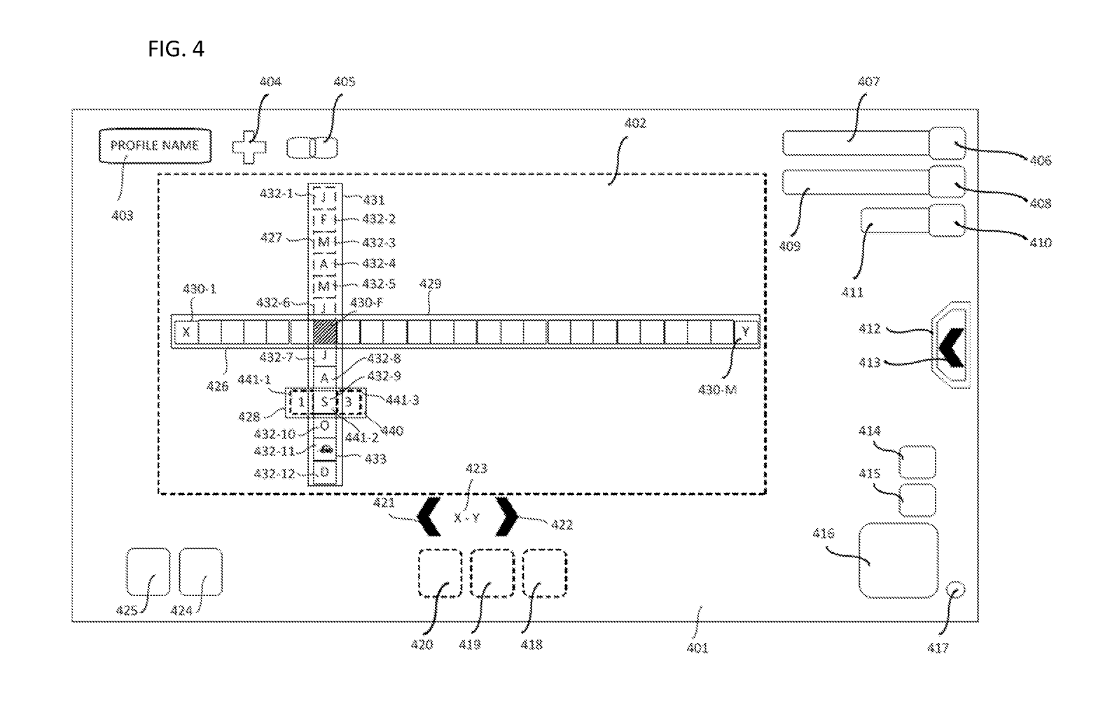

As explained previously, FMP 206 is responsible for generating, controlling and refreshing a GUI to enable user interaction with the financial planning system. FIG. 4 shows an example embodiment of the GUI 401 which is generated by FMP 206 of FIG. 2. GUI 401 further comprises canvas 402 and several objects. Each of these objects has its own functionality and one or more features, and will be described in detail in the following paragraphs.

User activation of some of these objects is described in the following paragraphs. Activation is achieved by, for example:
dragging a mouse pointer to the object and clicking;
touching the object using a finger on a touchscreen of a user device;
speaking appropriate voice commands; and
swiping the object using a finger on a touchscreen of a user device.

As explained previously, the tasks necessary for the operation of the FMP 206 are performed by the back end layer 202. In one example embodiment, the one or more financial application modelers 211 and 212 together with one or more of the:
profile database server 208;
the element properties database server 213; and
database components 209, 210, 215, 216 and 217;

perform the tasks necessary for the operation of the GUI. These tasks include, for example:
receiving user inputs as a result of the user activating the objects of the GUI,
processing these received inputs; and
displaying the outputs from the processing of these received inputs on the GUI using, for example, the objects of the GUI.

In one embodiment, the processing of the received inputs comprise performing one or more computational tasks and algorithms; and generating data to display on one or more tables, graphs and spreadsheets on the GUI. In another embodiment, the display of outputs from the processing of the received inputs comprises displaying one or more tables, graphs and spreadsheets on the GUI.

In one embodiment, GUI 401 comprises a profile name object 403, which when activated by the user displays the name of the current logged-in user accessing FMP 206. In another example embodiment, activation of this object by the user causes a drop-down menu to display. This drop down menu shows any additional user(s) created. In addition, this drop down menu has a “Logout” option. When the user chooses the “Logout” option, information related to the user is saved in the back-end databases 209 and 210 of FIGS. 2 and 3, and the user device being utilized by the user will log out.

In another embodiment, upon the user activating profile addition object 404, an “Add Additional Profile” feature is activated. This allows the user to, for example:
add a profile which has already been created on the website(s) to enable login from the mobile application 302 of FIG. 3;
create a new profile from the one or more login/registration pages 304 of mobile application 302; and
add an additional profile comprising one or more parameters directly captured from the GUI.

Activation of the merge profile object 405 by the user initiates the “Merge Profile” feature. This feature allows the data captured by two different profiles to be optimized and combined into one merged profile. This feature allows the financials to be looked at from a net-household standpoint. In one embodiment, the merge profile object 405 is represented by a “chain link” symbol as shown in FIG. 4.

User activation of the income details button 406 will show the details regarding the tally or the total that makes up the income category. These details comprise the user's salary, any one-time deposits and any sale of existing assets. These details are obtained using, for example:
the personal profile information related to the user and stored within databases 209 and 210 as previously described above; and
third party provider 104 via network 103 as shown in FIGS. 2 and 3 and as previously described above.

Activating the income indicator object 407 leads to the display of the current income of the active user. This is calculated using, for example:
the personal profile information related to the user and stored within databases 209 and 210 as previously described above; and
third party provider 104 via network 103 as shown in FIGS. 2 and 3 and as previously described above.

In one embodiment, the current income is represented in a standard scientific notation. In another embodiment, the current income is represented in a currency format. In a further embodiment, the currency used to represent the current income is based on the user's location. In one embodiment, the user supplies location data to the GUI. In another embodiment, the user's location is determined by, for example, examining the user's profile or by accessing geo-location devices on user device 101. In one embodiment, the user chooses whether income is represented in a monthly or yearly timeline format. In one embodiment, the user selects a timeline format via the “Settings” object 415.

Similar to objects 406 and 407, the objects 408 and 409 represent the expense details and expense indicator objects respectively. As with the income details, the expense details are, for example, either obtained from the personal profile information related to the user, or from third party provider 104 via network 103. The current expenses are calculated using either the personal profile information related to the user, or from third party provider 104 via network 103.

Activating dynamic variable indicator object 411 will display an overall total for a dynamic variable based on the user's selection. Examples of dynamic variables include taxes, insurance, assets, liabilities, net worth and other data. Dynamic variable details object 410 will show the details regarding the total for the selected dynamic variable. As with income and expenses, the dynamic variable details and amounts are either obtained from, or calculated using
the personal profile information related to the user, or
information from third party provider 104 provided via network 103.

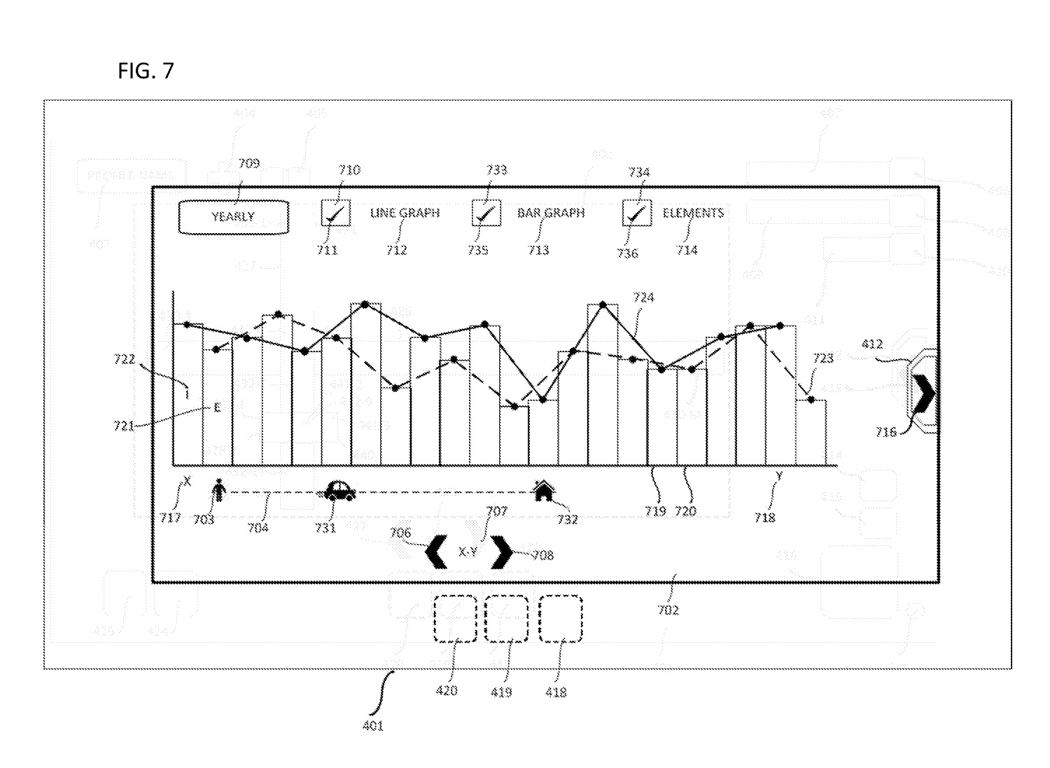

In response to the user activation of the leaf indicator object 412 with the left-pull arrow symbol 413, a panel 702 is pulled out sliding from right to left, as indicated in FIG. 7. As will be further explained, this results in a display of graphs for the user.

Object 414 is a canvas customize object which will be described in further detail below.

Activation of settings object 415 allows the user to change settings and user data in accordance with the user's preferences. As explained previously, in one embodiment, once a user is logged in, the user has the capability to amend or change the user's profile. Examples of settings which a user is able to change using settings object 415 comprise language settings, income settings, expense settings, currency settings, display settings, notification settings, user avatar and user favicons. In another embodiment, the user selects a representation timeline format for income via the settings object 415. In another embodiment, the user uses settings object 415 to customize the dynamic variable indicator object 411.

Activation of action log object 417 by the user opens an action log which tracks and displays any changes made by the user using the platform directly or indirectly.

The GUI Canvas and Elements

User activation of the shop element object 416 allows the user to select one or more elements corresponding to the user's life events. In one embodiment, these elements are grouped into categories including but not limited to: Family, Home, Education, Pets, Travel and Insurance. In one embodiment, the user selects an element using the shop element object 416, and then drags and drops the element to place it appropriately. In one embodiment, dragging and dropping is performed using, for example, a mouse. In another embodiment, the dragging and dropping is performed via a user interacting with a touchscreen of a mobile device using a finger.

These one or more elements will have one or more associated parameters. For example, if the element corresponds to a car purchase, example parameters comprise the car price, the term of the loan to purchase the car, and the monthly payment amount. Similarly for a house purchase, example parameters comprise the house price, the term of the mortgage and the monthly payments.

In one embodiment, canvas 402 comprises age ladder 426. Age ladder 426 represents the past, present and future years of the user to help better plan and forecast finances. Age ladder 426 comprises a set of age containers 429 having containers 430-1 to 430-M. Unlike many prior art systems which display calendar years, each age container within set 429 is marked with an age from an age range between ages X and Y. This has the advantage of enhancing the user interface so as to allow the user to correlate financial events more closely to age-related milestones. In one embodiment, the user selects the age range.

The left most age container 430-1 of age ladder 426 represents the lowest age X within the age range [X,Y], and the right most age container 430-M represents the highest age Y within the age range [X,Y]. The age containers between containers 430-1 and 430-M correspond to the ages within the age range [X,Y], and are arranged in ascending order respectively. In one embodiment, the age range [X,Y] is represented by age range object 423 in FIG. 4.

In one embodiment, the canvas 402 is too wide to display in its entirety within the screen. Then, the user uses left scroll object 421 or right scroll object 422 to scroll left or right and display the contents of the canvas 402 which cannot be displayed. This feature is useful if, for example, the user selects a large age range, causing the age ladder 426 and therefore the canvas 402 to be too wide to display in its entirety within the screen.

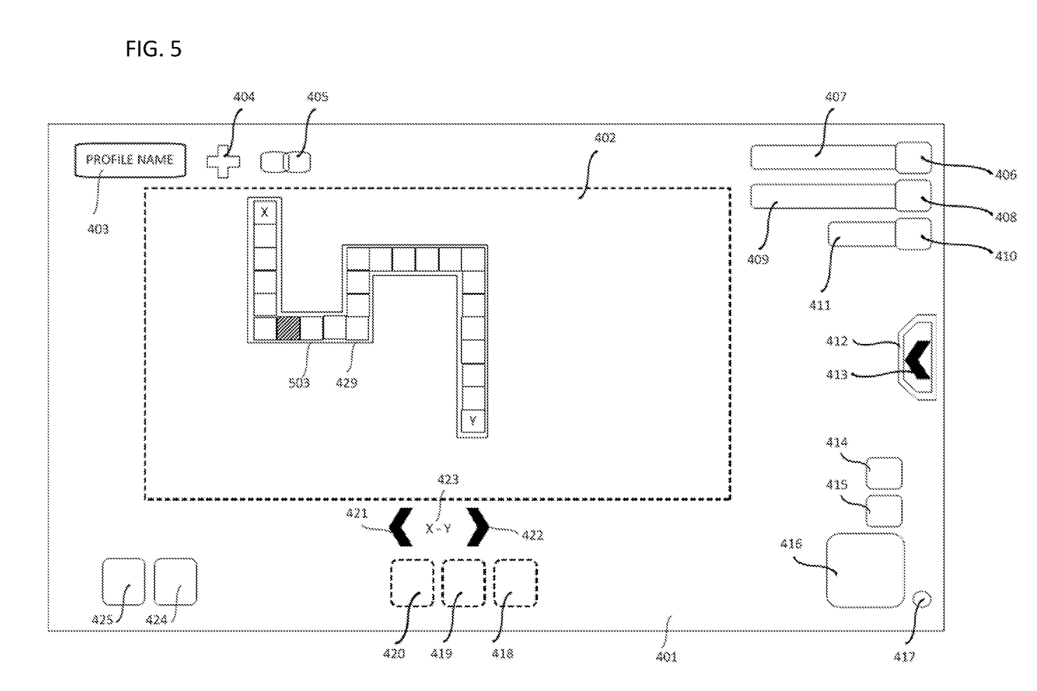

While the set of containers 429 in age ladder 426 are depicted as a horizontal line of boxes in FIG. 4, age ladder 426 and the set of age containers 429 are not limited to any particular orientation or container shape. In a further embodiment, activation of canvas customize object 414 allows the end user to customize and re-arrange the shape and orientation of the age ladder in accordance with their preferences. An example of this is shown in FIG. 5. In FIG. 5, an alternative arrangement 503 of the age ladder is shown. In arrangement 503, the set of age containers 429 are arranged using a mixture of horizontal and vertical segments.

In one embodiment, the user prompts the display of a month ladder on the canvas. FIG. 4 shows an example month ladder 427. The user prompts the display of the month ladder 427 by, for example, the user bringing a pointer using a mouse connected to the user device 101 close to age container 430-F within age ladder 426. In one embodiment, the user has to bring the pointer to “hover” over age container 430-F for the month ladder 427 to display on the canvas. In another embodiment, the user prompts the display of the month ladder 427 by touching age container 430-F on a touchscreen using a finger. In yet another embodiment, the user prompts the display of the month ladder 427 by dragging an element close to age container 430-F. Methods to drag the element close to one of the age containers are described further below.

The month ladder 427 contains a set of month containers 431. In FIG. 4, the set 431 comprises month containers 432-1 to 432-12 corresponding to a month of the year from January to December. As shown in FIG. 4, in one embodiment each of the month containers is labelled with the first letter of the month that the container corresponds to.

While FIG. 4 depicts the set of containers 431 in month ladder 427 as a vertical line of boxes in FIG. 4, month ladder 427 and the set of month containers 431 are not limited to any particular orientation or container shape.

In one embodiment, the month ladder is displayed on the GUI such that it is distinguishable from the age ladder. As shown in FIG. 4, the month ladder 427 is displayed on the canvas 402 such that it has a different orientation to the age ladder 426. While in FIG. 4 the age ladder 426 is horizontal and the month ladder 427 is vertical, it would be known to those of skill in the art that there are other methods to visibly distinguish between the age and month ladders.

In one embodiment, when the user prompts the month ladder to display, a first portion of the month ladder comprising a first portion of the set of month containers displays vertically adjacent to and above the age ladder, and a second portion comprising a second portion of the set of month containers of the month ladder displays vertically adjacent to and below the age ladder. This is demonstrated in FIG. 4. The first portion of the set of month containers comprises month containers 432-1 to 432-6 corresponding to the months of January to June, and the second portion of the set of month containers comprises month containers 432-7 to 432-12 corresponding to July to December. As can be seen, the first portion displays vertically adjacent to and above age ladder 426, and the second portion displays vertically adjacent to and below age ladder 426.

In a further embodiment, upon prompting the first and second portion of the month ladder are initially displayed with the containers having dashed lines. When the user performs an action indicative of the selection of one portion of the month ladder, the containers within the selected portion will then have solid lines. An example of this is demonstrated in FIG. 4. Since the user has performed an action indicative of the selection of the portion of the month ladder comprising containers 432-7 to 432-12, these containers have solid lines.

In an additional embodiment, the non-selected portion then fades away from the display. For example, when the first portion is selected and the user moves a pointer with a mouse towards the first portion, then
the containers within the first portion will have solid lines, and
the second portion fades away.

Referring to FIG. 4, the portion of the month ladder with containers 432-1 to 432-6 will then fade away.

In another embodiment, in response to the user prompting the month ladder to display, the entirety of the month ladder displays vertically adjacent to and above the age ladder. In another embodiment, the entirety of the month ladder displays vertically adjacent to and below the age ladder.

In one embodiment, the user drags and drops an element on the canvas 402. In one embodiment, this is achieved by the user first selecting an element such as element 433 using shop element object 416, then dragging the selected element 433 close to age container 430-F within age ladder 426. As explained previously, this prompts the month ladder 427 to display on the canvas. The user selects and drags the element using, for example:
a mouse pointer using a mouse connected to the user device 101; or
a finger on a touchscreen of the user device 101.

Once the month ladder 427 has displayed, the user drops the element into one of the month containers. As shown in FIG. 4, the user has dropped element 433 into container 432-11.

In another embodiment, once the user has dropped the element into one of the month containers, the corresponding age container is then marked differently from the empty age containers to indicate that the age container is now filled. For example, referring to FIG. 4, age container 430-F is marked differently from the empty age containers to indicate that the age container 430-F is now filled. This is achieved by, for example, marking filled age container 430-F with a different pattern to the empty age containers, such as shown in FIG. 4. Another way of marking filled containers differently from empty containers is by highlighting the filled containers.

In a further embodiment, once the user has dropped an element into one of the month containers, the month ladder 427 fades away to only leave the age ladder 426 visible.

While the rest of this specification describes operation using a month ladder, one of skill in the art would know that it is possible to have other ladders which describe periods within a year. Examples include week ladders, quarter ladders and half year ladders, each having their corresponding containers.

In a further embodiment, the user prompts a trio ladder to display on the canvas. For example, in FIG. 4 the user has prompted trio ladder 428 associated with month container 432-9 to display on canvas 402. The trio ladder 428 comprises a set 440 of three containers 441-1 to 441-3. These trio containers act as placeholders for the elements, and allow a user to enter multiple elements for the same month.

A user prompts the trio ladder to display using similar methods as those employed to prompt the month ladder to display. Referring to FIG. 4, the user prompts the trio ladder 428 to display by bringing a pointer using a mouse connected to the user device 101 close to month container 432-9. In one embodiment, the user brings the pointer to “hover” over month container 432-9 to prompt the trio ladder 428 to display on the canvas. In another embodiment, the user prompts the trio ladder 428 to display by touching month container 432-9 on a touchscreen using a finger. In yet another embodiment, the user prompts the trio ladder 428 to display by dragging an element close to month container 432-9.

In a further embodiment, some of the trio containers display in two portions on either side of the month container. An example of this is shown in FIG. 4:
the first portion containing the first trio container 441-1 displays on the left of the month container,
the second trio container 441-2 coincides with the month container, and
the second portion containing the third trio container 441-3 displays on the right of the month container.

In a further embodiment, as shown in FIG. 4 the first trio container 441-1 is marked with “1” and the third trio container 441-3 is marked with “3”. Since the middle trio container 441-2 coincides with the month container, the middle trio container is not marked with the number “2”.

In the situation where the trio containers are displayed in two portions, in a further embodiment, initially the trio ladder displays with all containers having dotted lines. Similar to the situation where the month ladder displays with two portions, when the user performs an action indicative of selection of one of the portions, the containers within the selected portion will have solid lines. In another embodiment, the non-selected portion fades away from the display.

Other methods of display of the trio containers are also possible. In one embodiment, all three containers display to the left of the month container. In another embodiment, all three containers display to the right of the month container. In these embodiments where all three trio containers display either left or right of the month container, the containers are marked with “1” to “3”.

While the examples above describe the use of three containers, it would be known to one of skill in the art that it would be possible to have more or less than three containers.

As explained previously, the trio containers are placeholders for the same month. Then, the user drags and drops an element on the canvas 402, by dragging and dropping the element into one of the trio containers. Dragging and dropping the element into one of the trio containers is achieved by:
selecting an element using shop element object 416,
performing a first dragging action comprising dragging the selected element close to one of the age containers within age ladder 426. As explained previously, this causes the month ladder to display on the canvas. The user selects and drags the element using, for example:
   a mouse pointer using a mouse connected to the user device 101 close to one of the age containers, or
   a finger on a touchscreen of the user device 101;
performing a second dragging action comprising dragging the selected element close to the desired month container within the month ladder. This causes the trio ladder to display on the canvas;
dropping the selected element into one of the displayed trio containers. In one embodiment, once the user has dropped the element into one of the trio containers, the trio ladder and month ladder fade away to only leave the age ladder 426 visible. In another embodiment, once the element is dropped into the trio container:
   the month container corresponding to the trio container, and
   the age container corresponding to the month container

are marked differently from the empty containers to indicate that the age and month containers are non-empty. For example, the month and age containers are highlighted to distinguish over the empty age containers. In another embodiment, the month and age containers are filled with a different pattern to the empty age containers.

The user is able to drag and drop a plurality of elements onto the canvas, as long as there is sufficient space within either the month or trio containers to accommodate the plurality of elements, by repeating the above described processes. In one embodiment, the user drags and drops elements from different categories onto the canvas. For example, a user is able to drag and drop a house element, car element and education element onto the canvas. In another embodiment, the users drag and drop multiple elements from the same category onto the canvas. For example, the user drags and drops a first house element and a second house element onto the canvas corresponding to a personal dwelling and an investment property respectively. The user is edits the parameters of each of the first and the second house element as required. Then the age and month ladders will show one or more non empty containers corresponding to the containers where the elements have been dropped.

In the case of a merged profile, the canvas will display merged age, month and trio ladders as long as there is sufficient space to do so.

In a further embodiment, after
an element is dropped into either a month container or a trio container for the first time, or
the user activates a filled month container or trio container,

then the GUI displays objects 418, 419 and 420 as shown in FIG. 4. In one embodiment, these objects are displayed via dashed outline around the object icon perimeter.

When calendar view object 418 is activated, a calendar view which interacts with a calendar on user device 101 is displayed, to enable the user to add/delete/edit calendar reminders.

When element parameter edit object 419 is activated, the parameters of element 433 are displayed. In one embodiment, initially default parameter values are displayed on activation when the element is first dropped into the month or trio container. In one embodiment, these default parameter values are retrieved from databases 215-217 via financial application modelers 211 and 212 and element properties database server 213 of FIG. 2. Then, the user enters the desired values corresponding to the parameters. In one embodiment, financial application modelers 211 and 212 interact with profile database server 208 to store the desired values within databases 209 and 210. When the user wishes to edit the element parameters after initial entry, the user activates element parameter edit object 419. One or more financial application modelers 211 and 212 interact with profile database server 208 and databases 209 and 210 to store the new values entered by the user.

When the user activates element parameter quick view object 420, the element parameter information is displayed. This allows for a “quick view” of the element parameters. In one embodiment, when element parameter quick view object 420 is activated, one or more financial application modelers 211 and 212 work together with profile database server 208 to retrieve the information from databases 209 and 210 in conjunction with element properties database server 213 and respective database 215, 216 and 217.

In a further embodiment, GUI 401 comprises a delete element object 424. Delete element object 424 allows the user to delete an element from a month or trio container. In one embodiment, the user deletes an element such as element 433 by dragging and dropping the element from a month or trio container onto object 424. In one embodiment, when an element is deleted, financial application modelers 211 and 212 work together with profile database server 208 to delete the information from databases 209 and 210.

Users also are able to edit element parameters as necessary. In one embodiment, the user first prompts the display of the month or trio ladder when either of these are already not displayed. Methods to prompt the display of the month or trio ladder have been described previously. When the month or trio ladder is displayed, the user then prompts the display of element parameter edit object 419. This is achieved by either:
dragging a pointer to hover over the month or trio container containing an existing element such as element 433 and clicking, or
tapping on the month or trio container containing an existing element such as element 433, by using a finger on a touchscreen of the user device 101.

The user then activates element parameter edit object 419 and edits the element parameter settings as necessary. As explained previously, financial application modelers 211 and 212 work together with profile database server 208 to change the information stored in databases 209 and 210.

Users are also able to move an element from its current month or trio container to a new month or trio container on the GUI. In one embodiment, when the user wishes to change the month container for element 433, then as explained above for editing element parameters, the user first prompts the display of the month ladder or trio ladder when either of these is already not displayed. Methods to prompt the display of the month or trio ladder have been described previously.

The user then drags the element 433 from its current month or trio container and drops it into a new month or trio container by, for example:
bringing the pointer to hover over the month or trio container containing element 433,
clicking on the month or trio container, and then
dragging the element 433 and dropping the element 433 into the new month or trio container as explained previously.

In another embodiment, dragging the element 433 from its current month or trio container and dropping it into a new month or trio container is performed by, for example:
tapping the month or trio container containing element 433 using a finger on a touchscreen, and then
dragging the element 433 and dropping the element 433 into the new month or trio container using the finger on a touchscreen.

In another embodiment, GUI 401 comprises a recent quick pick element object 425. The purpose of this object is to
reduce the number of steps that user has to navigate using the standard “shop element” object 416 when selecting elements,
allow the user to select the most recently used element,
allow the user to select “favorite” or most frequently used elements.

In a further embodiment, a ladder data set corresponding to the user is stored within one or more of the databases 209 and 210 in the back end layer. The ladder data set is used to display the age, month and trio ladders corresponding to the user. This data is linked to the user profile. Changes made on the canvas 402 within the age, month and trio ladders are stored in the ladder data set by the one or more financial application modelers 211 and 212 working together with profile database server 208, database 209 and database 210. When two users' profiles are merged, the ladder data sets corresponding to the users' profiles are combined into a merged ladder data set by, for example, profile database server 208, database 209 and database 210 working together with one or more financial application modelers 211 and 212. This merged ladder data set is then used to create a display of a merged ladder on the GUI.

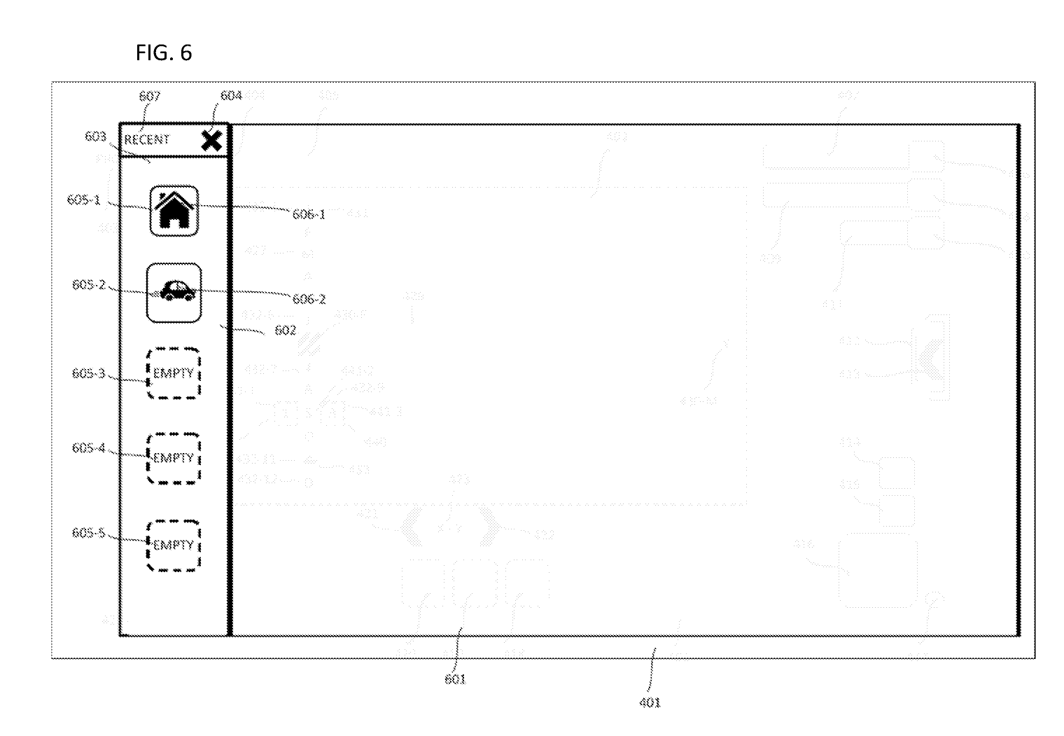

Referring to FIG. 4, when the user activates object 425, as shown in FIG. 6 an element pull-out panel 602 is displayed. Pull-out panel 602 further comprises a placeholder panel 603 containing one or more placeholder containers 605-1 to 605-5. Some of the one or more placeholder containers 605-1 to 605-5 will have elements within, such as, for example house element 606-1, car element 606-2. In a further embodiment, some of the one or more placeholder containers are left empty, such as, for example, placeholder container 605-3 to 605-5. Object 603 displays the top header for pull-out panel 602.

Once the user has finished using pull-out panel 602, the user closes pull-out panel 602 either by activating pull-out panel close object 604 or by clicking or tapping the pointer outside pull-out panel 602, such as in area 601. In a further embodiment, in order to highlight the focus on the panel 602 for the user, the panel overlaps all the other objects and reduces the transparency for those objects as shown in FIG. 6. In a further embodiment, element pull-out panel 602 will have a heading such as heading 607. Heading 607 is, for example, “RECENT”, as shown in FIG. 6.

As previously explained, user activation of the leaf indicator object 412 with the left-pull arrow symbol 413 results in the activation of graph view object 702. A panel sliding from right-to-left is pulled out, as indicated in FIG. 7 and left-pull arrow symbol 413 is changed to right-pull arrow object 716. When graph view object 702 is closed, right-pull arrow object 716 reverts to left arrow symbol object 413.

Activating graph view object 702 results in the graphical display of one or more data sets which utilize:
the element parameters related to the one or more elements which have been dragged and dropped onto the canvas 402,
personal profile information related to the user and stored in one or more databases 209 and 210 as described previously, and
information obtained from third party provider 104 via network 103 as described previously.

These data sets include, for example
income(s),
expense(s),
tax(es),
total asset value(s),
liabilities, and
net worth.

As shown in FIG. 7, period view object 709 allows the user to adjust the period of display for the one or more data sets. The object 709 has several modes available for selection by the user. In one embodiment, as shown in FIG. 7 the default mode is “YEARLY”. Also, as shown in FIG. 7.

Object 710 is a line graph checkbox placeholder object, as further indicated by line graph text object 712. In response to activation of object 710, checkmark 711 is displayed. This causes a line graph to display. Similarly, object 733 is a bar graph checkbox placeholder object, as further indicated by line graph text object 713. In response to activation of object 733, a checkmark 735 for a bar graph display is displayed within object 733. This causes a bar graph to display. In one embodiment activation of both objects 712 and 733 results in line and bar graphs being displayed within graph view object 702.

Object 734 is an element display checkbox placeholder object, as further indicated by elements display text object 714. Upon activation, object 734 will contain checkmark 736. In response to activation, elements which have been dragged and dropped onto the age, month and trio ladders within the canvas 402 are graphically represented along with the line or bar graphs.

In one embodiment, a graphical display age range [X,Y] for the graphical display is set. In one embodiment, this age range corresponds to the age range used in object 423 in FIG. 4. In another embodiment, the range for the graphical display is set by the user. This graphical display age range is displayed via graphical age range display object 707. Objects 717 and 718 display the lowest age X and the highest age Y within the graphical display age range.

As explained previously, when the user activates line graph checkbox placeholder object 710 as shown in FIG. 7, then data sets are visually represented using line graphs. Object 724 displays the income data represented by a solid line and similarly object 723 displays the expense data represented by a dashed line. In one embodiment, the income and expense line graphs for the graphical display age range are displayed in an alternating fashion based on the object 709. For example, if, as shown in FIG. 7, the object 709 is set to “YEARLY”, then the income and expenses for each year within the age range [X,Y] are displayed in an alternating fashion. That is, income for age X is followed by expenses for age X which is then followed by income for age (X+1) and so on until age Y is reached. This is also demonstrated in FIG. 7, where the solid line graph object 724 representing income alternates with the dashed line graph 723 representing expenses.

When, as shown in FIG. 7 the user activates bar graph checkbox placeholder object 733, then data sets are visually represented using bar graphs. In FIG. 7, bar graph objects 719 and 720 are bar graphs for income and expenses respectively. In one embodiment, similar to as described above for the line graphs, the bar graphs are displayed in an alternating fashion based on the object 709. In an embodiment, the graph for one data set is marked differently from the bar graph for a different data set using different text objects. For example, as shown in FIG. 7, the income and expense bar graphs are represented via text object 722 “I” and text object 721 “E” respectively. In a further embodiment, when one of the bars within a bar graph object is activated, then a breakdown of the corresponding data for that period will be shown. For example, when the bar corresponding to age X for income bar graph object 719 is activated, then a breakdown of the user's income for age X will be shown.

When, as shown in FIG. 7, the user activates element display checkbox placeholder object 734, then the elements which the user has dragged and dropped on the age, month and trio ladders in canvas 402 are displayed. For example, in FIG. 7, the car element 731 and house element 732 are displayed below the graphs via timeline object 704. The placement of car element 731 and house element 732 reflect the locations where these elements were dropped on the age and month ladder within canvas 402. Current age object 703 represents the user's current age which was captured at the time of profile creation.

In one embodiment, the user adjusts the range of the data displayed on the graph using the left graph scroll and right graph scroll objects 706 and 708 respectively.

When either of elements 731 or 732 is activated, then the calendar view object 418, element parameter view object 419, and element parameter quick view object 420 also appear. This allows the user to view and edit the element parameters as necessary.

In one embodiment, as shown in FIG. 7, the transparency of the display area of GUI 401 outside of graph pull out window object 702 is reduced. This improves the user's focus on graph pull out window object 702.

In embodiments where the user is viewing a merged profile, then the graph view object 702 will graphically display one or more merged data sets corresponding to the merged profiles and merged ladder data sets.

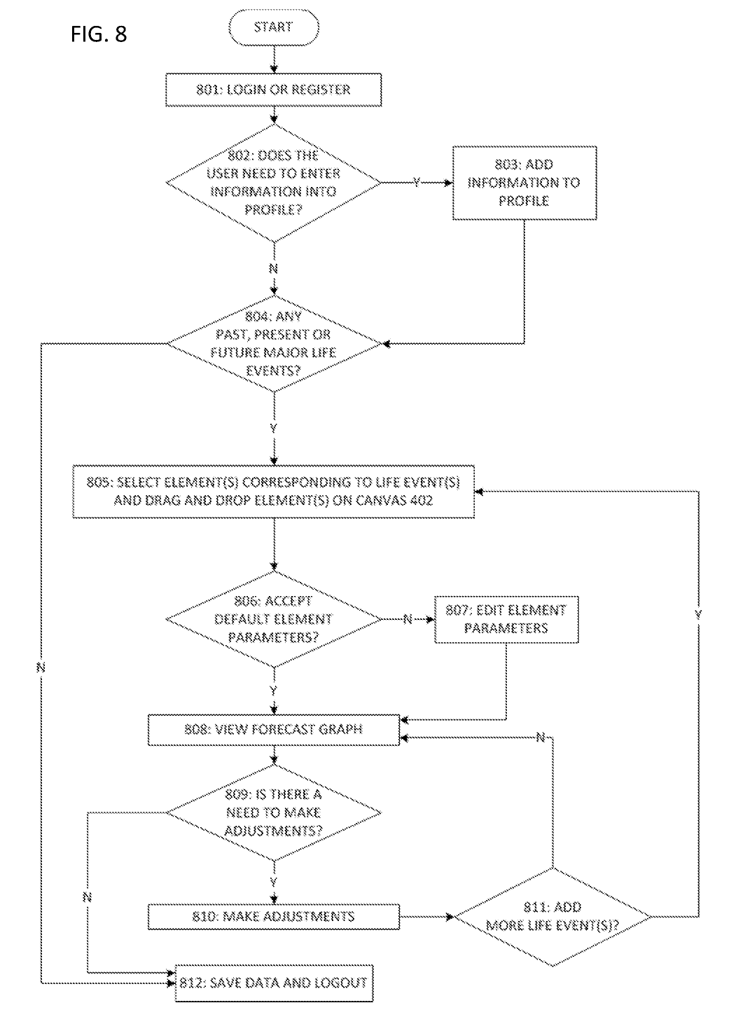

FIG. 8 shows how an example flow of a user interaction with the graphical user interface that is the subject of this specification. In step 801, the user either logs in or registers using, for example, the one or more login/registration pages 205 in layer 201 of FIG. 2, or the one or more login/registration pages 304 in layer 301 of FIG. 3. Processes for a user to log in or register have been described previously.

Next, when the user decides in step 802 that information such as personal and financial details needs to be added into the user's profile, this is performed in step 803. As explained previously, this is performed using, for example, the one or more login/registration pages 205 of FIG. 2; or one or more login/registration pages 304 of FIG. 3. As explained previously, the information supplied by the user is, for example, stored by the profile database server 208 in databases 209 and 210. When the user decides not to enter information in step 802 or the user finishes entering the information in step 803, then the user proceeds to step 804.

In step 804, the user decides whether there are any past, present or future life events that need to be added. When the user decides not to add any life events, then the user proceeds to step 812, that is, the user saves data and logs out utilizing, for example, profile name object 403.

When the user decides to add one or more past, present or future life events in step 804, then in step 805 the user selects, then drags and drops one or more elements corresponding to the one or more life events on canvas 402 of GUI 401 of FIG. 4. Processes to select elements have been described in detail above. The user uses, for example, shop element object 416 of FIG. 4 or quick pick element object 425 of FIG. 4 to select elements for dragging and dropping. Once the one or more elements have been selected, the user drags and drops the elements onto, for example, month ladder 427 of FIG. 4 or trio ladder 428 of FIG. 4 as described in detail previously.

As explained previously, initially default parameters are displayed for the one or more elements when they are first dropped onto the month ladder 427 or trio ladder 428 of FIG. 4. In step 806, for each of the elements, when the user decides not to accept these default element parameters, then the user edits the element parameters in step 807. Processes to edit element parameters using, for example, element parameter edit object 419 of FIG. 4 have been described in detail previously.

Once this is complete, in step 808 the user generates one or more graphs of forecasts or projections of data sets over the user's selected age range. As explained previously, the graph is generated by, for example, activating graph view object 702 of FIG. 7. The user customizes the graph display as necessary using the objects of FIG. 7 as explained previously.

After viewing the graphs, when the user decides in step 809 that there is no need to make adjustments, then the user proceeds to step 812, that is, the user saves the data and logs out.

When the user decides in step 809 that there is a need to make adjustments such as:
moving at least one of the one or more elements to different time periods,
editing parameters corresponding to at least one of the one or more elements, and
deleting at least one of the one or more elements,

then in step 810, the user makes these adjustments. Processes to perform these adjustments have been described in detail above.

After making the adjustments, in step 811 when the user decides not to add one or more life events, then the user returns to step 808 and re-enters the flow. When the user decides to add one or more life events, then the user returns to step 805 and re-enters the flow. The user is able to either add one or more life events, or make adjustments as many times as necessary and review the impact on the forecasts.

The usage of the age, month and trio ladders within the user interface enhances the user interface so as to allow the user to better visualize and correlate multiple financial events more closely to age-related milestones on a user device, when compared to the prior art. Using the containers within the month and trio ladders as placeholders for elements also improves user visualization of the impact of these elements on the user's finances on a screen of a user's device. When combined with the drag and drop capabilities, this leads to a highly usable interface which allows a user to better visualize and understand the impact of life events on the user's finances, from a mobile device or a laptop.

The various other objects described above further enhance the user interface over prior art systems. For example, using the “merge profile” object to initiate the “merge profile” feature allows for user to better understand overall household finances. The combination of this feature with the ladder objects and the drag and drop capabilities allow the user to better visualize the impact of multiple financial elements on the household finances in relation to the user's age on a user device.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A graphical user interface (GUI) for one or more user devices associated with one or more users to interact with a financial planning system, wherein
said one or more user devices are coupled to said financial planning system via a network;
said financial planning system comprises a financial modeling platform (FMP) to
generate said GUI for display on said one or more user devices, said GUI further comprising
an age ladder comprising a set of age containers, and
one or more elements, and
manage said GUI; and
wherein said financial planning system receives commands from at least one of said one or more user devices using said GUI to
prompt the display of a month ladder comprising a set of month containers at said at least one user device based on one or more interactions with said age ladder, and
drop at least one element selected from the one or more elements into at least one of the set of month containers.

2. The system of claim 1, wherein said display of the month ladder comprises displaying a first and second portion of the month ladder, wherein
some of said set of month containers is displayed within the first portion of the month ladder;
some of said set of month containers is displayed within the second portion of the month ladder;
the first and second portions of said set of month containers are initially displayed using dashed lines, wherein
responsive to receiving at least one command from said at least one user device indicative of selecting one of the first and second portions of the month ladder, said selected portion of the month ladder is displayed using solid lines.

3. The system of claim 1, wherein said age ladder is displayed using a horizontal line of boxes corresponding to the set of age containers.

4. The system of claim 3, wherein said month ladder is displayed using a vertical line of boxes corresponding to the set of month containers.

5. The system of claim 1, further wherein said GUI comprises a shop element object; and said selection of said at least one element is performed using said shop element object.

6. The system of claim 1, further wherein said GUI comprises a quick pick element object; and
said selection of said at least one element is performed using said quick pick element object.

7. The system of claim 1, further wherein said GUI enables graphical display of data based on said dropping of said at least one element, said graphical display further comprising either displaying a line graph or a bar graph.

8. The system of claim 1, wherein said GUI comprises a delete element object.

9. The system of claim 1, wherein said financial planning system comprises one or more financial application modelers to facilitate operation of said FMP.

10. The system of claim 1, wherein said GUI comprises an element parameter edit object.

11. A method for one or more user devices to interact with a financial planning system over a network, wherein
said one or more user devices is coupled to said financial planning system over the network, further wherein
said financial planning system comprises a financial modeling platform (FMP); and
said method further comprising
generating a graphical user interface (GUI) for display on said one or more user devices using said FMP, wherein said GUI comprises
an age ladder comprising a set of age containers, and
one or more elements;
managing said GUI using said FMP;
receiving commands from at least one of said one or more user devices using said GUI to
prompt display of a month ladder comprising a set of month containers at said at least one user device based on one or more interactions with said age ladder;
select at least one element from the one or more elements; and
drop said selected at least one element into at least one of the set of month containers.

12. The method of claim 11, wherein said display of the month ladder comprises displaying a first and second portion of the month ladder, wherein
some of said set of month containers is displayed within the first portion of the month ladder;
some of said set of month containers is displayed within the second portion of the month ladder;
the first and second portions of said set of month containers are initially displayed using dashed lines, wherein
responsive to receiving commands from at least one user device indicative of selecting one of the first and second portions of the month ladder, said selected portion of the month ladder is displayed using solid lines.

13. The method of claim 11, further comprising displaying said age ladder using a horizontal line of boxes corresponding to the set of age containers.

14. The method of claim 13, further comprising displaying said month ladder using a vertical line of boxes corresponding to the set of month containers.

15. The method of claim 11, further wherein said GUI comprises a shop element object; and
said selecting of said at least one element is performed using said shop element object.

16. The method of claim 11, further wherein said GUI comprises a quick pick element object; and
said selecting of said at least one element is performed using said quick pick element object.

17. The method of claim 11, further wherein said GUI enables graphical display of data based on said dropping of said at least one element, said graphical display further comprising either displaying a line graph or a bar graph.

18. The method of claim 11, wherein said GUI comprises a delete element object.

19. The method of claim 11, wherein said GUI comprises an element parameter edit object.

20. A system for one or more user devices associated with one or more users to interact with a financial planning system over a network,
wherein said one or more user devices is coupled to said financial planning system over the network, further wherein
said financial planning system comprises a financial modeling platform (FMP) to
generate a graphical user interface (GUI) for display on said one or more user devices, said GUI further comprising
an age ladder comprising a set of age containers, and
one or more elements, and
manage said generated GUI;
wherein said financial planning system receives commands from at least one of said one or more user devices using said GUI to
prompt the display of a month ladder comprising a set of month containers at said at least one user device based on one or more interactions with said age ladder,
prompt the display of a trio ladder comprising a set of trio containers at said at least one user device based on one or more interactions with said month ladder, and
drop at least one element selected from the one or more elements into at least one of the set of trio containers.
